(19) United States
(12) Patent Application Publication
(10) Pub. No.: US 2004/0085046 A1
(43) Pub. Date: May 6, 2004

(54) Power conditioning system for turbine motor/generator

(75) Inventors: Zhihong Ye, Clifton Park, NY (US); Gautam Sinha, Clifton Park, NY (US); Luis Jose Garces, Clifton Park, NY (US)

Correspondence Address: FOLEY AND LARDNER, SUITE 500, 3000 K STREET NW, WASHINGTON, DC, 20007, US

(73) Assignee: General Electric Company, Schenectady, NY (US)

(21) Appl. No.: 10/065,596

(22) Filed: Nov. 1, 2002

(51) Int. Cl. H02P 3/00; H02P 9/06; H02P 11/00; H02P 15/00

(52) U.S. Cl. 322/13

(57) ABSTRACT

A motor/generator power conditioner is provided with a rectifier electrically coupled to a motor/generator port, and an inverter electrically coupled to the rectifier and to a load port. In a startup mode, the combined rectifier and inverter provides startup power to the motor/generator port. In an operational mode, the combined rectifier and inverter provides generated power to the load port and generates a neutral output.

### BACKGROUND OF THE INVENTION

The present invention relates generally to motor/generator power conditioners, and more particularly, to power conditioning systems for turbine motor/generators.

Turbine motor/generators (including microturbine motor/generators) are commonly used in power generation applications, such as backup turbogenerators in hospitals, airports, etc. One such turbine motor/generator is described in U.S. Pat. No. 6,020,713 (the '713 patent hereafter), which is incorporated by reference herein in its entirety. The '713 patent describes known turbogenerators including a rotor assembly having a plurality of equally spaced magnet poles of alternating polarity around the outer periphery of the rotor, the rotor assembly being rotatable within a stator having a plurality of windings and magnetic poles of alternating polarity.

In order start the turbogenerator, electric current is supplied to the stator coils of the permanent magnet generator/motor to operate the permanent magnet generator/motor as a motor and thus to accelerate the gas turbine of the turbogenerator. To supply the startup power, the '713 patent includes a power supply coupled to the stator coils of the permanent magnet via a supply rectifier and a switching inverter. During this acceleration, spark and fuel are introduced in the correct sequence to the combustor and self-sustaining gas turbine conditions are reached. At this point, the power supply is disconnected from the turbogenerator, and the turbogenerator acts as a supply of power to an external load. Specifically, power is supplied by the turbo generator after reconfiguring the switching inverter to a controlled 60 hertz mode, and changing from the supply rectifier to a power supply rectifier different from the supply rectifier.

The aforementioned turbogenerator of the '713 patent suffers, however, from a large electrical component footprint due to the inclusion of two distinct rectifiers.

Another power conditioning system for turbogenerators is described in U.S. Pat. No. 5,008,801 (the '801 patent hereafter), which is incorporated by reference herein in its entirety. The '801 patent discloses a power conditioning system that supplies startup power to the stator coils from an external power source via an inverter and a single combination rectifier/filter. For applications that require a neutral output provided to the load, the '801 patent uses an output auto-transformer to generate the neutral. Due to the inclusion of a separate auto-transformer, the power conditioning system of the '801 patent also suffers from a large electrical component footprint, and lower efficiency due to the transformer.

### BRIEF SUMMARY OF THE INVENTION

According to one embodiment of the present invention, a motor/generator power conditioner is provided with a rectifier electrically coupled to a motor/generator port, and an inverter electrically coupled to the rectifier and to a load port. In a startup mode, the combined rectifier and inverter provides startup power to the motor/generator port. In an operational mode, the combined rectifier and inverter provides generated power to the load port and generates a neutral output.

According to another embodiment of the present invention, a method of controlling a motor/generator is provided, comprising supplying startup power to the motor/generator via a rectifier electrically coupled to an inverter, conditioning generated power from the motor/generator via the rectifier and the inverter, and generating a neutral output via the combined rectifier and inverter while conditioning generated power.

According to another embodiment of the present invention, a motor/generator power conditioner is provided with means for supplying startup power to the motor/generator, means for conditioning generated power from the motor/generator, and means for generating a neutral output from the means for conditioning generated power.

According to another embodiment of the present invention, a motor/generator power conditioner is provided with a three-leg active rectifier electrically coupled to a motor/generator port, a four-leg inverter electrically coupled to a load port, a bi-directional DC power bus electrically coupling the rectifier to the inverter, and a neutral output coupled to one of the legs of the inverter.

### BRIEF DESCRIPTION OF THE DRAWINGS

FIG. 1 is a block diagram of a power conditioning system according to an embodiment of the present invention.

FIG. 2 is an enlarged view of a switching device and a diode according to an embodiment of the present invention.

FIG. 3 is a block diagram of the power conditioning system of FIG. 1 in an operating mode according to an embodiment of the present invention.

FIG. 4 is a block diagram of the power conditioning system of FIG. 1 in a startup mode according to an embodiment of the present invention.

FIG. 5 is a block diagram of a power conditioning system in a startup mode according to another embodiment of the present invention.

### DETAILED DESCRIPTION OF THE INVENTION

Reference will now be made in detail to presently preferred embodiments of the present invention. Wherever possible, the same reference numbers will be used throughout the drawings to refer to the same or like parts.

For purposes of explanation only, the preferred embodiments of the present invention will be described in reference to turbine motor/generators (i.e., motor/generators with a turbine prime mover). However, it should be appreciated that the present invention is applicable to more devices than simply turbine motor/generators, such as diesel gensets (i.e., motor/generators with a diesel engine as the prime mover).

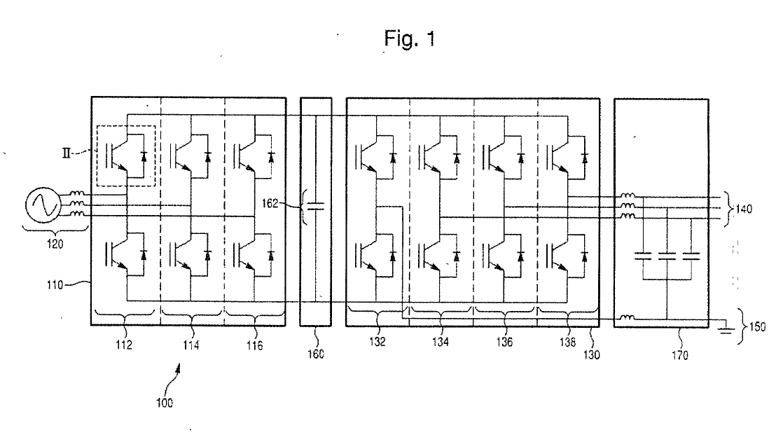

A power conditioning system 100 according to a first embodiment of the present invention is shown in the schematic of FIG. 1. As shown, the power conditioning system 100 includes a rectifier 110 electrically coupled to a turbine motor/generator 120. The rectifier 110 is also electrically coupled to an inverter 130, which in turn is electric-ally coupled to a load port 140. Preferably, load port 140 is selectably coupled to an external power source (e.g., a power grid which is not shown) for supplying startup power, and also selectably coupled to one or more electrical load(s).

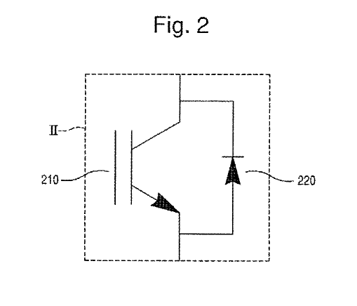

The rectifier 110 preferably comprises an active rectifier as shown in FIG. 1 (i.e., comprises primarily active components rather than known passive diode rectifiers). For three phase power supply applications, the rectifier 110 is configured as a “three leg” active rectifier, each leg 112,114,116 of the rectifier 110 corresponding to one of the three phases generated by/supplied to the motor/generator 120. It should be appreciated, however, that more or less legs can be added/removed for power supply applications other than three phase input (e.g., a two leg, four leg, etc. application). As shown in the enlarged view of FIG. 2, each leg 112,114,116 of the rectifier 110 includes a plurality of switching devices 210 (e.g., a pair of insulated gate bipolar transistors (IGBT)), each of the plurality of switching devices 210 being electrically coupled in parallel to a respective diode 220 in a known manner.

Similar to the active rectifier 110, the inverter 130 also preferably comprises an active inverter 130 (FIG. 1). Each leg 132, 134,136,138 of the inverter 130 includes a plurality of switching devices 210 (e.g., a pair of FETs), each of the switching devices 210 being electrically coupled in parallel to a respective diode 220 in a known manner in the same way as in the rectifier 110. Unlike the rectifier 110, however, the inverter 130 preferably comprises a “four leg” active inverter 130 (or one more leg than the rectifier 110 for applications other than three phase output). Specifically, each of three legs 134,136,138 of the active inverter 130 correspond to one of the three phases outputted to the load port 140. In addition, a fourth leg 132 is provided corresponding to a neutral output 150 generated by the combined rectifier 110/inverter 130. This neutral output 150 can be referred to as a generated neutral.

It should be appreciated that even though only a two stage rectifier 110 and inverter 130 is shown (i.e., each leg having only two switching devices 210 in series), multi-stage conversion with more than two stages may be used, for example, in high voltage power generation applications.

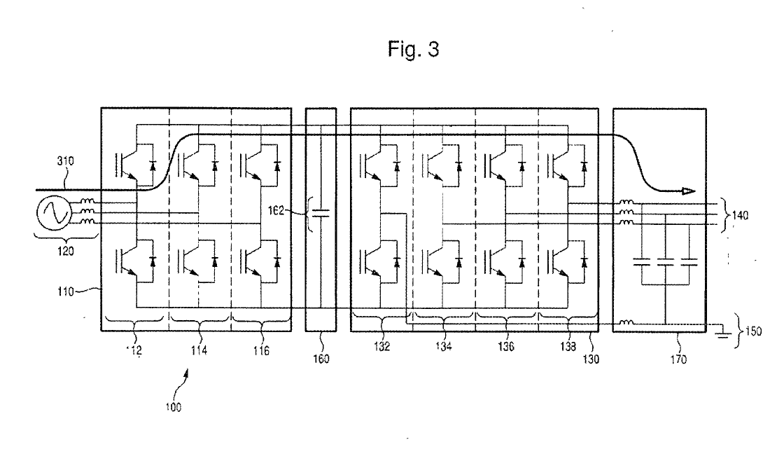

During an operating mode shown in FIG. 3, the rectifier 110 converts alternating current (AC) power supplied by the turbine motor/generator 120 to a direct current (DC) power. The DC power is supplied to the inverter 130 via a bi-directional DC power bus 160. DC bus capacitor 162 is positioned across the bi-directional DC power bus 160 to filter the voltage supplied to the inverter 130.

DC power supplied by the rectifier 110 during the operating mode is converted to a 60 hertz AC power by the inverter 130. For purposes of explanation only, the power flow for a single phase passing through the power conditioner 100 during the operating mode is labeled 310 (FIG. 3). The 60 hertz AC power is then outputted to the load via the load port 140, preferably after filtering with output filter 170. DC to AC power conversion is provided by switching the inverter 130 at a constant 60 hertz rate in a known manner. The generated neutral 150 provided off of the combined rectifier 110/inverter 130 is filtered from any switching induced current surges by the output filter 170. By providing the generated neutral directly off of the combined rectifier 110/inverter 130, an additional transformer or other additional components can be eliminated.

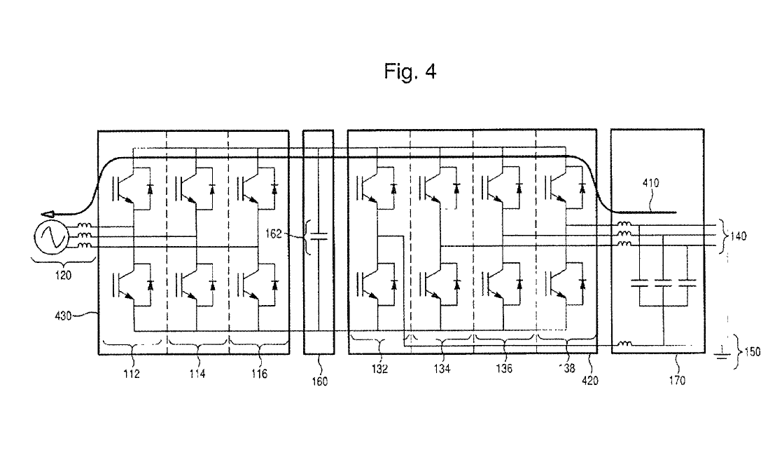

As shown in FIG. 4, the role of rectifier 110 and inverter 130 of FIG. 1 reverses in a starting mode. For purposes of explanation only, the power flow for a single phase passing through the power conditioner 100 in the startup mode is labeled 410. It should be appreciated that the rectifier 420 and inverter 430 shown in FIG. 4 correspond to the inverter 130 and rectifier 110 respectively, as previously described with respect to FIG. 1. For purposes of explanation, FIG. 4 re-labels the former rectifier 110 and inverter 130 to inverter 430 and rectifier 420, respectively, to correspond to their “swapped” function in the startup mode.

Preferably, during the startup mode, an AC power is supplied to the rectifier 420 (corresponding to operating mode inverter 130), which converts the AC power to a DC power. The DC power is supplied to the inverter 430 (corresponding to operating mode rectifier 110) via the bi-directional DC power bus 160. The inverter 430 is operated by a control unit (not shown) to provide AC power under a suitable control law (e.g., at a constant volts-per-hertz ratio) to the turbo motor/generator 120 armature windings. The control unit gradually increases the fundamental frequency produced by (and the switching rate of) the inverter 430 to accelerate the turbine motor/generator 120 up to speed in a known manner. Once the turbine motor/generator 120 is up to an operating speed, the inverter 430 and rectifier 420 are reversed, and operate in the operating mode previously described.

As described above, the preferred embodiments of the present invention provides a reversible or reconfigurable turbine power conditioning system 100 having a reduced footprint over known turbine power conditioning systems. Thus, the cost of manufacturing and maintaining the turbine power conditioning system 100 is reduced.

It should be appreciated, however, that a preferred embodiment of the present invention also provides for startup power generation without requiring use of a separate starter circuit. Separate startup circuits are commonly used to produce a variable voltage generally greater than that of the power source alone for applications such as turbine motor/generator startup.

By eliminating the separate startup circuit, the preferred embodiment of the present invention can further reduce the footprint of the turbine power conditioning system, and thus achieve a corresponding reduction in the cost and complexity of the turbine power conditioning system. Even though the separate startup circuit is not required for the present invention, it should be appreciated that a separate startup circuit can still be used in conjunction with embodiments of the present invention if desired, depending on the particular implementation.

In addition to the aforementioned footprint reductions, the present inventors have also found that the aforementioned turbine power conditioning system 100 can be adjusted to select a particular power factor desired for a given implementation. In general, the “power factor” of an output refers to the ratio of real power to apparent power in the outputted power, as described, for example, in the Internet published technical note TN-002 entitled “Power Factor: Definition and Application” by Asea Power Systems, which is incorporated by reference herein in its entirety. The power factor is related to the phase angle between voltage and current when there is a clear linear relationship. But it can still be defined when there is no apparent phase relationship between voltage and current, or when both voltage and current take on arbitrary values.

Power factor is a simple way to describe how much of the current contributes to real power in the load. A power factor of one (unity or 1.00) indicates that 100% of the current is contributing to power in the load while a power factor of zero indicates that none of the current contributes to power in the load. Purely resistive loads such as heater elements typically have a power factor of unity, the current through them is directly proportional to the voltage applied to them. Capacitive and inductive (motor) loads typically have a power factor of zero and the current through them is defined in a more complicated way.

The current in an AC line can be thought of as consisting of two components: real and imaginary. The real part results in power absorbed by the load while the imaginary part is power being reflected back into the source, such as is the case when current and voltage are of opposite polarity and their product, power, is negative.

The reason it can be important to have a power factor as close as possible to unity is that once the power is delivered to the load, it is undesirable to have much (if any) of it reflected back to the source. It takes current to transfer the power to the load, and it takes current to carry it back to the source. Hence, efficiency will be reduced by incurring power reflected back to the source.

The present inventors have found that the aforementioned turbine power conditioning system 100 allows the power factor to be adjustable by manipulating the current control loop reference of the rectifier 110 and/or inverter 130. The active rectifier 110 simultaneously and independently permits regulation of the DC bus 160 voltage and control of the input (generator) current power factors. For example, setting the q-axis reference current (Iqref) to 100 A and d-axis current reference (Idref) to 50 A would cause the rectifier 110 to draw input currents with a power factor of 0.89 leading with respect to the rectifier voltage. Conversely, setting Iqref to 100 A, and Idref to 0 A would cause the rectifier 110 to draw generator currents at 1.0 power factor. In both cases, the same amount of power is delivered by the rectifier 110 to the DC bus 160. Preferably, the power factor of the turbine power conditioning system 100 is set to be greater than or equal to about 0.95 to have a minimal amount of power reflected back to the turbine motor/generator 120. In some cases, however, such as at light loads or reactive power compensation, a lower power factor (e.g., about zero) is sometimes desired to maintain controllability of the rectifier 110 or to provide leading reactive power to help system voltage regulation.

Thus, a preferred embodiment of the present invention allows for a designer of a motor/generator power conditioning system 100 to have a wide degree of latitude when selecting the power factor for a particular application. This can improve the efficiency of the power conditioning system, and/or provide power factors in ranges not previously achievable in known devices.

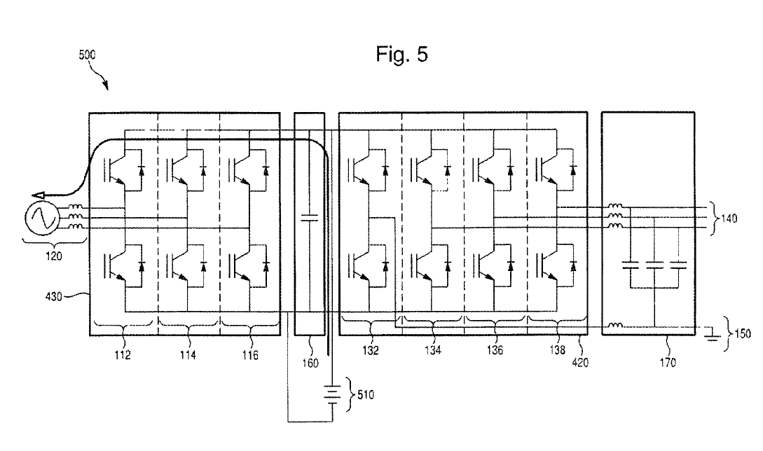

A power conditioning system 500 according to a second embodiment of the present invention is shown in the schematic of FIG. 5. It should be appreciated that this second embodiment is substantially similar to that of the first embodiment of the present invention in many respects. However, in contrast to the first embodiment in which load port 140 is selectably coupled to an external power source for supplying startup power, a power conditioning system 500 according to this second embodiment includes a startup power source 510 (e.g., a battery, fuel cell, etc.) coupled to the DC bus 160. For purposes of explanation only, the power flow for a single phase passing through the power conditioner 500 in the startup mode is labeled 510.

During the startup mode, DC power is supplied to the inverter 430 from the startup power source 510 via the bi-directional DC power bus 160. The inverter 430 is then operated by a control unit (not shown) as previously described to provide AC power at a constant volts-per-hertz ratio to the turbine motor/generator 120 armature windings and accelerate the turbine motor/generator 120. Thus, the rectifier 410 does not need to convert AC power from the load port 140 to a DC power for the inverter 430.

During the operating mode, DC power rectified by the rectifier 110 (FIG. 1) from the turbine motor/generator 120 can then be used to recharge the startup power source 510 (FIG. 5), provided the startup power source 510 is rechargeable by application of DC power on the DC power bus 160 (e.g., recharging a battery by applying a steady DC power). In other startup power source 510 applications such as a fuel cell, the startup power source 510 can be selectably disengaged from the DC power bus 160.

The aforementioned motor/generator power conditioning system 500 can thus provide startup power for applications where a steady power source selectably coupleable to the load port 140 is not readily available. These conditions may be found, for example, in microturbine motor/generators used to provide power in a environment (e.g., a carnival, craft show, etc.).

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A motor/generator power conditioner, comprising:
a rectifier electrically coupled to a motor/generator port; and
an inverter electrically coupled to the rectifier and to a load port,
wherein in a startup mode, the combined rectifier and inverter provides startup power to the motor/generator port, and
wherein in an operational mode, the combined rectifier and inverter provides generated power to the load port and generates a neutral output.

2. The motor/generator power conditioner of claim 1, further comprising:
a DC power bus capable of bi-directional power flow electrically coupling the rectifier to the inverter; and
a bus capacitor positioned in parallel to the DC power bus.

3. The motor/generator power conditioner of claim 2, further comprising a startup power source is coupled to the DC power bus,

4. The motor/generator power conditioner of claim 3, wherein in the operational mode the startup power source is recharged by at least one of the rectifier and the inverter.

5. The motor/generator power conditioner of claim 1, wherein the rectifier comprises an active rectifier.

6. The motor/generator power conditioner of claim 5, wherein the rectifier comprises a three-leg rectifier comprised of:
a plurality of switching devices; and
a plurality of diodes, each of said diodes being electrically coupled in parallel to a respective corresponding switching device.

7. The motor/generator power conditioner of claim 1, wherein the inverter comprises a four-leg inverter comprised of:
a plurality of switching devices; and
a plurality of diodes, each of said diodes being electrically coupled in parallel to a respective corresponding switching device,
wherein one of the four legs is electrically coupled to the neutral output.

8. The motor/generator power conditioner of claim 1, wherein the combined rectifier and inverter provides sufficient generated power and sufficient startup power without a separate starter circuit.

9. The motor/generator power conditioner of claim 1, further comprising a separate starter circuit for producing the startup power.

10. The motor/generator power conditioner of claim 1, wherein a power factor of the generated power is adjustable.

11. The motor/generator power conditioner of claim 1, wherein a power factor of the generated power is greater than about 0.95 leading or lagging.

12. The motor/generator power conditioner of claim 1, wherein a power factor of the generated power is about zero.

13. The motor/generator power conditioner of claim 1, further comprising a prime mover for the motor/generator.

14. The motor/generator power conditioner of claim 13, wherein the prime mover for the motor/generator comprises one of a turbine and a diesel motor.

15. The motor/generator power conditioner of claim 1, wherein the motor/generator power conditioner is a two stage conditioner.

16. A method of controlling a motor/generator, comprising:
supplying startup power to the motor/generator via a rectifier electrically coupled to an inverter;
conditioning generated power from the motor/generator via the rectifier and the inverter; and
generating a neutral output via the combined rectifier and inverter while conditioning generated power.

17. The method of claim 16,
wherein supplying startup power to the motor/generator comprises supplying sufficient power to the motor/generator absent a separate starter circuit, and
wherein conditioning generated power from the motor/generator comprises conditioning sufficient power from the motor/generator absent a separate starter circuit.

18. The method of claim 16, further comprising:
adjusting a power factor of the generated power.

19. The method of claim 16, wherein the power factor of the generated power is greater than about 0.95 leading or lagging.

20. A motor/generator power conditioner, comprising:
means for supplying startup power to the motor/generator;
means for conditioning generated power from the motor/generator; and
means for generating a neutral output from the means for conditioning generated power.

21. A motor/generator power conditioner, comprising:
a three-leg active rectifier electrically coupled to a motor/generator port;
a four-leg inverter electrically coupled to a load port;
a bi-directional DC power bus electrically coupling the rectifier to the inverter; and
a neutral output coupled to one of the legs of the inverter.

22. The motor/generator power conditioner of claim 21,
wherein in a startup mode, the combined rectifier and inverter provides startup power to the motor/generator port, and
wherein in an operational mode, the combined rectifier and inverter provides generated power to the load port and a neutral for the neutral output.

23. The motor/generator power conditioner of claim 22 wherein a power factor of the generated power is adjustable.

24 The motor/generator power conditioner of claim 22 wherein a power factor of the generated power is greater than about 0.95 leading or lagging.
